(19) United States
(12) Patent Application Publication
(10) Pub. No.: US 2012/0278747 A1
(43) Pub. Date: Nov. 1, 2012

(54) METHOD AND APPARATUS FOR USER INTERFACE IN A SYSTEM HAVING TWO OPERATING SYSTEM ENVIRONMENTS

(75) Inventors: Binu Abraham, Round Lake, IL (US); Joshua D. Galicia, Cary, IL (US); Andrew N. Tzakis, Vernon Hills, IL (US)

(73) Assignee: MOTOROLA MOBILITY, INC., Libertyville, IL (US)

(21) Appl. No.: 13/096,303

(22) Filed: Apr. 28, 2011

(51) Int. Cl. G06F 3/048

(52) U.S. Cl. 715/771

(57) ABSTRACT

An apparatus (110) and method (700) for user interface in a multi-environment operating system is provided wherein a first operating system (first OSE) (222) controls the states of a set of applications of the first OSE. Each application is controlled to be in one of at least a closed state, an open-running state, and an open-suspended state. A second OSE (224) renders a set of application status indicators (326, 340) on a graphical user interface (312) each of which indicates an identity and a current state of one of the open applications of the first OSE. The second OSE determines a user input to alter the state of an identified one of the open applications to a different state. The second OSE communicates to the first OSE an identity of the identified application and the different state. The second OSE changes the rendering of the application status indicator of the identified application to indicate the different state.

### RELATED APPLICATION

This application is related to U.S. application Ser. No. ______, filed on ______, which is entitiled “METHOD AND APPARATUS FOR LOCKING AND UNLOCKING MULTIPLE OPERATING SYSTEM ENVIRONMENTS WITH A SINGLE GESTURE INPUT, and assigned to the assignee hereof.

### FIELD OF THE INVENTION

The present invention relates generally to multi-environment operating systems and in particular, to a method and apparatus for user interface with applications of the multiple operating system environments.

### BACKGROUND OF THE INVENTION

Software functions that display a set of application statuses are provided in single operating system environments such as Microsoft Windows®, where they may appear in a system status bar. There are also functions that display the statuses of browser windows by using tabs. Software features that control groups of commands are provided within certain software applications such as Microsoft Excel®, wherein they may be referred to as ribbons.

Some mobile devices have the capability to utilize multiple run-time environments simultaneously on a single processor. A user of such a device may operate a first operating environment (e.g., Android) and a second operating environment (e.g., GNU Linux) simultaneously. When operating such a device, at least two co-existing independent middleware operating environments coupled to a core kernel are provided where the middleware operating environments each have a corresponding application component.

When a single display device is utilized as a user interface to a mobile device running multiple operating system environments (e.g., Android and GNU Linux), there may exist two windows on the display device. A first window may exist on a first portion of the display (e.g., an Android window that shows the Android environment). A second window, or background window, may also exist on the display (e.g., a background window showing a GNU Linux desktop environment). The user interaction can be confusing or cumbersome when the user attempts to interact with applications of one of the operating system environments.

### BRIEF DESCRIPTION OF THE DRAWINGS

FIG. 1 is a diagram of a mobile device;

FIG. 2 is a software/hardware architectural block diagram of the mobile device;

FIG. 3 is a diagram of an external device;

FIG. 4 is a software/hardware architectural block diagram of the mobile device, detailing a runtime co-existence schema of a software environment.

FIG. 5 is a block diagram of a runtime co-existence schema of a software environment;

FIG. 6 is block diagram of an inter-environment communication schema of an exemplary operating system;

FIG. 7 is a flow chart that shows some steps of a method of rendering an OSE window in a window (WIW) of a desktop of a second OSE;

FIG. 8 is a flow chart that shows some steps of a method for modifying graphical data generated by an operating system environment;

FIG. 9 is a flow chart that shows some steps of a method of initializing a WIW;

FIG. 10 is a flow chart that shows some steps of a method of rendering the WIW of FIG. 9;

FIG. 11 is a flow chart that shows some steps of a method of initializing a WIW;

FIG. 12 is a flow chart that shows some steps of a method of rendering the WIW of FIG. 11.

FIG. 12 is a block diagram that shows some hardware blocks of the mobile device.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments that include the present invention. Also, common but well-understood elements that are useful or necessary in a commercially feasible embodiment are often not depicted in order to facilitate a less obstructed view of these various embodiments, which include the present invention. It will further be appreciated that certain actions and/or steps may be described or depicted in a particular order of occurrence while those skilled in the art will understand that such specificity with respect to sequence is not actually required in all instances. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to provide for efficient rendering of a window of a first operating system within a desktop of a second operating system, some embodiments are described.

The present invention encompasses a method comprising the following steps.

Controlling by a first operating system environment (first OSE) the states of a set of applications of the first OSE. Each application is controlled to be in one of at least a closed state, an open-running state, and an open-suspended state.

Rendering by a second operating system environment (second OSE) a set of application status indicators on a graphical user interface each of which indicates an identity and a current state of one of the open applications of the first OSE. The open applications comprise the applications that are in the open-running and open-suspended states

Determining by the second OSE a user input to alter the state of one of the applications (an identified application) of the open applications to a different state that is one of at least closed, open-running, and open-suspended.

Communicating by the second OSE to the first OSE an identity of the identified application and the different state to the first OSE.

Changing by the second OSE the rendering of the application status indicator of the identified application to indicate the different state.

The present invention further encompasses an apparatus comprising a central processing unit (CPU) existing on a device. The CPU performs the steps of executing a first operating system environment and executing a second operating system environment that provide the features described in the above method.

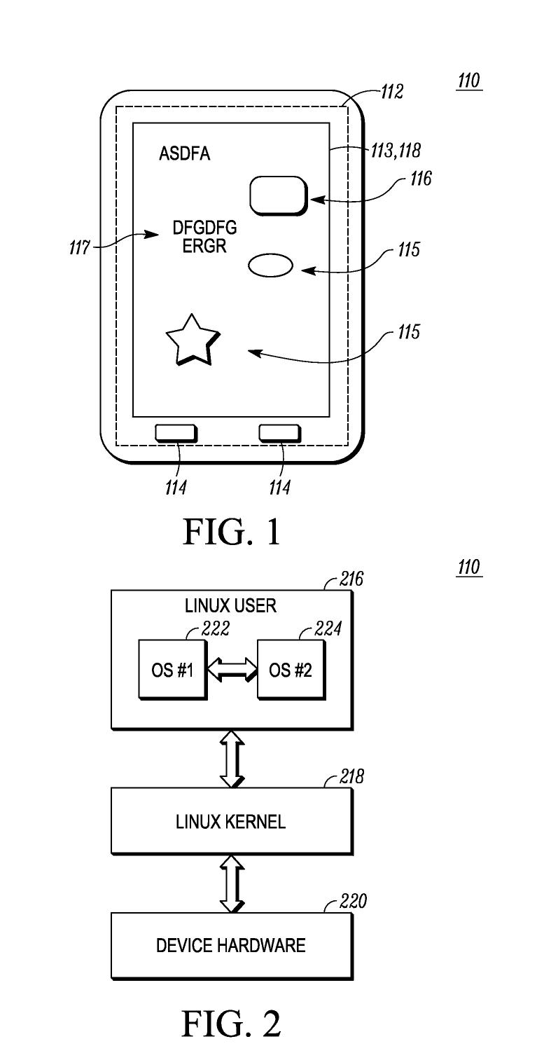

Turning now to the drawings, where like numerals designate like components, FIG. 1 shows a diagram of a mobile device 110 that is a mobile telephone, in accordance with some embodiments. The mobile device 110 includes a graphical user interface GUI 112 that comprises a display screen 113 (alternatively, display or screen) and a plurality of physical buttons 114. The physical buttons may be of the type called soft buttons, for which their functions are defined by text or graphics on the display 113. The GUI 112 provides input and outputs for human interfacing to software that operates the mobile device 110. The mobile device 110 is selected from the group including, but not limited to, a mobile personal computer (PC), a netbook, a mobile telephone, a laptop computer, a handheld computer and a smart phone. Although the device 110 is mobile, it is intended to have significant computing power, with a processor speed in excess of 500 MHz, although slower processors are not excluded. Considering the computing power, a user can connect the mobile device 110 to a variety of peripheral devices (not shown in FIG. 1). The peripheral devices are selected from a group including, but not limited to, computer monitor, a laptop computer, a desktop computer, a tablet PC, and a screen projector. FIG. 2 illustrates some graphical icons. In some embodiments the display 113 is a touch screen display. The display can display one of a plurality of windows generated by an OSE executing an application. The display 113 shown in FIG. 1 is displaying a full screen window 118. By full screen window is meant a window that determines the color and intensity of light for all the pixels on the screen 113. In some embodiments, all windows generated for the mobile device are all full screen windows. Shown on the display 113 and window 118 are some graphical icons 115, a virtual button 116, and some text 117.

Referring to FIG. 2, a software/hardware architectural block diagram of the mobile device 110 shows an exemplary software environment 216 in communication with a Linux kernel 218, in accordance with some embodiments. The software environment 216 comprises applications that each run on within one of multiple operating system environments, and shows an example of two operating system environments. Certain portions 220 of the hardware of the mobile device 110 are also in communication with the Linux kernel 218. The software environment 216 includes a first operating system environment (OSE) 222 and a second operating system environment (OSE) 224 in communication with the Linux kernel 218, which is a single kernel. These operating system environments are also described herein as middleware, because they operate using the Linux kernel 218 to interact with the memory and hardware elements of the mobile device 110. The first OSE 222 and the second OSE2 24 each execute in their own native mode. By example, the second operating system environment 224 is a standard Linux distribution and the first operating system environment 222 is an embedded operating system environment intended for use in mobile devices, such as an Android™ (Open Handset Alliance, www.openhandsetalliance.com) operating system. The software environment 216 is in communication with the Linux kernel 218, which is in communication with the device hardware 220.

An exemplary software environment 16 includes Ubuntu® (Canonical Ltd., www.ubuntu.com) for the Linux-based operating system environment 224. The multiple middleware operating system environments co-exist independent of the other(s). Exemplary environments that can be included in software environment 216 include Android™ (Google, Inc., www.google.com), Ubuntu® (Canonical Ltd., www.ubuntu.com), standard Linux-based environments, Symbian (Symbian Foundation Ltd., www.symbian.com), and Windows-based environments. In an alternative embodiment, it is envisioned that greater than two operating system environments are configured to co-exist independently on the same core kernel 218.

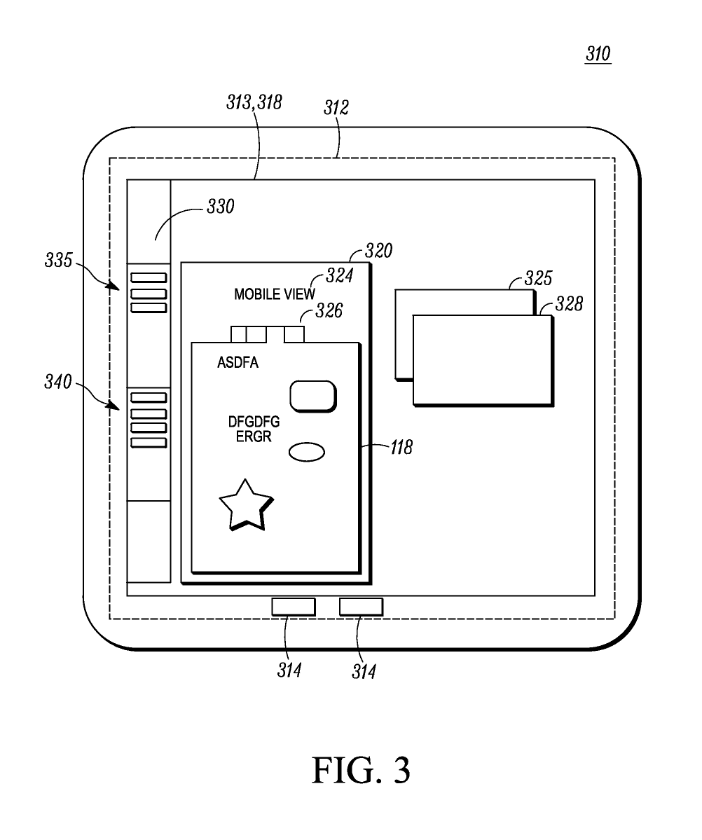

Referring to FIG. 3, a diagram shows an external device 310 that comprises a second GUI 312 having a touch sensitive display 313 and may comprise some physical buttons 314, in accordance with some embodiments. The display 313 may be a touch screen display. The physical buttons may be of the type called soft buttons, for which their functions are defined by text or graphics on the display 313. A physical keyboard (not shown in FIG. 3) may be a part of the second GUI 312. The second GUI 312 provides input and outputs for human interfacing to software that operates the mobile device 110 and the external device 310. The external device 310 can be coupled to the mobile device 110 either by wired (for example, High Definition Multimedia Interface [HDMI]) or wireless (for example, Bluetooth) means. A docking station (not shown in FIG. 3) may be provided for the mobile device 110 to plug into. The docking station may then provide a wired or wireless connection to the external device 310, which may be a TV monitor or a digital display monitor such as used for laptops. The docking station may incorporate or couple to a physical keyboard. The external device 310 may comprise only sufficient electronics to accept display information over the coupling means and drive the display 313 of the second GUI with the information, and to accept user touch inputs from the display and physical buttons on the second GUI.

In one embodiment the external display comprises an external monitor attached to device 100 via a HDMI cable. As shown, external display 313 renders a desktop 318 this is a full screen desktop and therefore has the same boundary as the display 313. The desktop includes a system status bar 330 that shows the statuses of windows that are open, each window being generated by an application that is being executed by the second OSE. In FIG. 3, windows 320, 325, 328 are open. In this particular embodiment, window 320 is a window generated by an application being executed by the second OSE that duplicates the window 118 and may add additional graphics, such as tabs 326 and a title 324. As discussed above, the first OSE 22 and the second OSE 24 operate independently from each other, and co-exist with respect to the other. Each OS 22, 24 is a fully functioning operating system environment, and does not need the other operating system environment to function. The two operating system environments exist on the same mobile device 100 with independence with respect to the other.

It should be noted that although not shown clearly in windows 325 and 328, each window 325, 328 would contain icons and graphics that represent standard applications that are being executed by the second OSE.

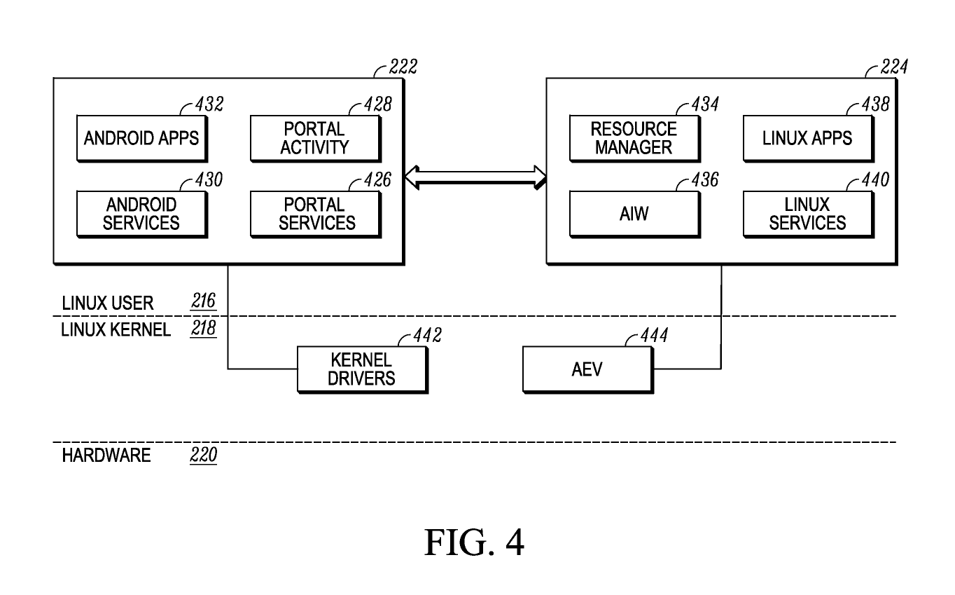

Referring to FIG. 4, a software/hardware architectural block diagram of the mobile device 110 is shown, detailing a runtime co-existence schema of a software environment, in accordance with some embodiments. In the present exemplary embodiment, the first OSE 222 is an Android™ based operating environment and the second OS environment 224 is Ubuntu® The first operating system environment 222 includes a portal service module 426, a portal activity module 428, an OS services module 430 and a set of first OS applications 432. The second operating system environment 424 includes a resource manager 434, an Android in a window (AIW) module 436, a set of second OS applications 438 and a second OS services module 440. In embodiments in which the first OSE 222 is something other than Android, AIW can be referred to as a window in a window WIW.

In some embodiments, the AIW module 436 is configured to display a first OSE window 118 within a window 320 that is rendered on the desktop portion of the GUI display 313 of the external device 310 (FIG. 3). The second OSE 224 drives the second GUI 312 of the external device 310.

The portal service module 426 directs all communication with the resource manager 434. Additionally, the portal service module 426 is connected to activity associated with the portal activity module 428, as well as first OSE 222 broadcast events.

The second OSE 224 provides a desktop presentation 318 that may be presented on the display 313 of the second GUI 312. The desktop 318 is similar to desktops presented on laptop and desktop computers, having a background (wallpaper) area, and a system and an application status area (a Taskbar in Microsoft Windows terminology). One application or a plurality of applications that are being executed on the second OSE 224 may be presented simultaneously on the desktop 318. One of the applications is deemed to have “focus” at any given time, meaning that user interaction with that application is primarily by means of the window of that application. (That is to say, very few user interactions can be made by means other than the window that is in focus. An example is that the window may be maximized, minimized or closed by a user action within the region of the status bar). The application can also respond to system events. Each application window is controlled by the second OSE 224 to have a particular position. The second OSE application (e.g., one of 320, 325, 328 that is in focus is controlled by the second OSE 224 to be identifiable as being in focus by being given unique visual characteristics (such as a different border color, for example). Application windows may or may not overlap on the display of the second GUI, but when they do, each is controlled to appear in some layer order behind the second OSE window that is in focus. (e.g., if window 320 of FIG. 3 is in focus, then if window 325 or 328 were moved to overlap window 320, they would appear to be behind window 320).

Certain ones of the applications that execute on the first OSE 222 can present differing windows that are each usable on the first GUI display 113, one at a time. The window that is being rendered at a given time for the first GUI 112 is herein termed the first OSE window 118. In some embodiments, every first OSE window 118 is a full screen window. The first OSE window 118 presents graphical information from a first OSE application, that is to say, an application that is being executed on the first OSE 222. Examples are the home screen, a phone book application, a game application, and a web browser application. For some of the first OSE applications the first OSE 222 may also present graphical information relevant to certain system states (e.g., call indicator, signal strength, time, battery status, etc.). This combined presentation is rendered on the first GUI display 113 by commands of the first OSE 222 that use the graphical information from one of the first OSE applications. This first OSE window 118 can be used for the purpose of user interface with the first OSE 222, including interaction with the first OSE application that is generating graphical information for the first OSE window 118. For simplicity, and in more general terms, this document describes such a user interaction as being “with the OSE” that includes the OSE application that is providing much of the graphics for the window, it being understood that the user inputs are passed through the OSE to the OSE application.

The kernel 218 includes a set of drivers 442 and an AEV module 444. Included with the drivers 442 are input device drivers for hardware components 220. The AEV 444 is a kernel module that takes absolute coordinate and keyboard events from AIW 436 when it has focus and passes them to an event hub.

The co-existing operating system environments within operating system 16 communicate with each other. The resource manager 434, which is part of the second OSE 224, communicates directly with the portal service module 426, which is part of the first OSE 222. Furthermore, the portal service module 426, which is part of the first OSE 222, communicates directly with the resource manager 434. The resource manager 434 is a set of instructions configured to manage resources shared by the first OSE 222 and second OSE 224. The shared resources may include display devices, input devices, power management services and system state information. Furthermore, the resource manager 434 is configured to control OSE 222 and OSE 224 access to the hardware 220. Additionally, the resource manager 434 identifies and controls which OSE user interface is displayed through each of the first GUI 112 and second GUI 312

According to the present embodiment, the portal service 426 is the source of all communications from the first OSE 222 to the resource manager 434. Additionally, the portal service 426 is a sink for all callbacks from the resource manager 434 to the first OSE 222. The resource manager 434 provides a status discoverable application programming interface (API) to the portal service 426. This API is configured to be called by the resource manager 434 at any time. The resource manager 434 is configured to obtain and process runtime status, which allows for the resource manager to maintain a state machine. For the first OSE 222, the portal service 426 provides runtime status to processes that require them. Similarly, the portal service 426 requests and receives status updates from processes which provide status information. A similar communication for the second OSE 224 is controlled by the resource manager 434, which provides runtime status to the processes that require them. Resource manager 434 requests and receives status updates from various processes that provide status information. Device drivers 442 logically associated with the kernel 218 communicate directly with the resource manager 434 as well as the processes that provide runtime status information. By example, the API arbitrates access to user interface devices, such as displays, touch screens or the GUIs. Yet another example, the API arbitrates access to power input devices, such as batteries and/or AC/DC wall plugs.

The first OSE 222 and the second OSE 224 are independent from the other, and co-exist with respect to the other. Each OSE 222, 224 is a fully functioning operating system environment, and does not need the other operating system environment to function. The two operating system environments exist on the same device 110 with independence with respect to the other. As identified above, the first and second OSE 222, 224 do not co-exist in a virtualization or emulation scheme, but in fact each operates in its native mode on a single kernel 218. There is runtime co-existence in which both OSE 222, 224 run in their respective native environments and neither OSE 222, 224 is recompiled, as there is no need to leverage a common C runtime environment. Applications can be accessed by a user which are coded purely for one or the other OSE 222, 224 without an interruption to a user's computing experience.

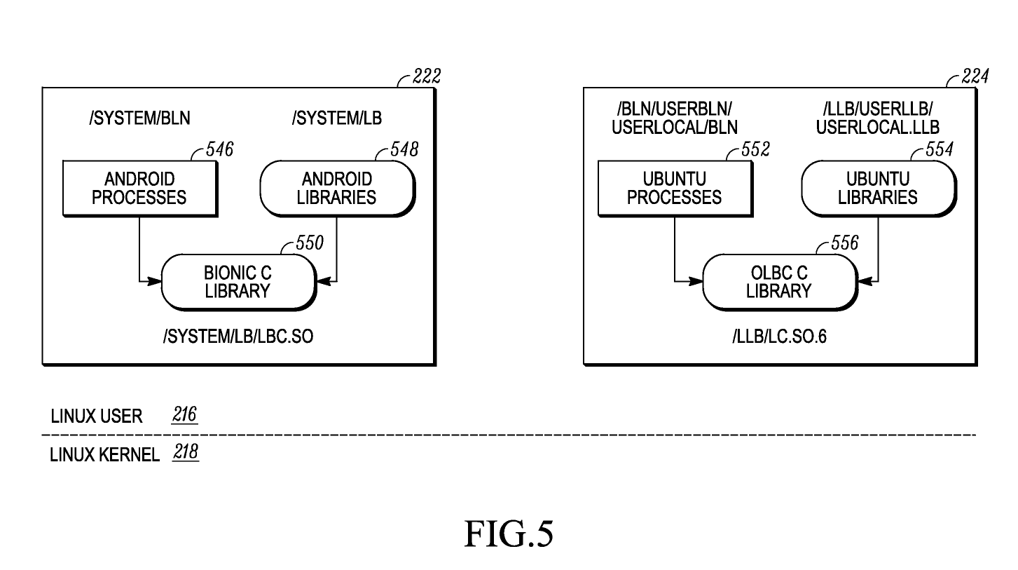

Referring to FIG. 5, a block diagram shows a co-existence scheme for an Android® OSE 222 and an Ubuntu® OSE 224, in accordance with some embodiments. Each OSE 222, 224 operates on a separate runtime environment, which provides software services for programs and/or processes while the device 100 is operating. Android processes 546 and Android libraries 548 access a Bionic C Library 550, which is optimized and modified specifically for the Android environment. Ubuntu processes 552 and Ubuntu libraries 554 access a Glibc C Library 556, which is a GNU C library used in many standard desktop Linux-based systems. Each OSE runs on its respective C libraries without conflicting with another operating environment. These attributes are also true in embodiments using other types of OSE's.

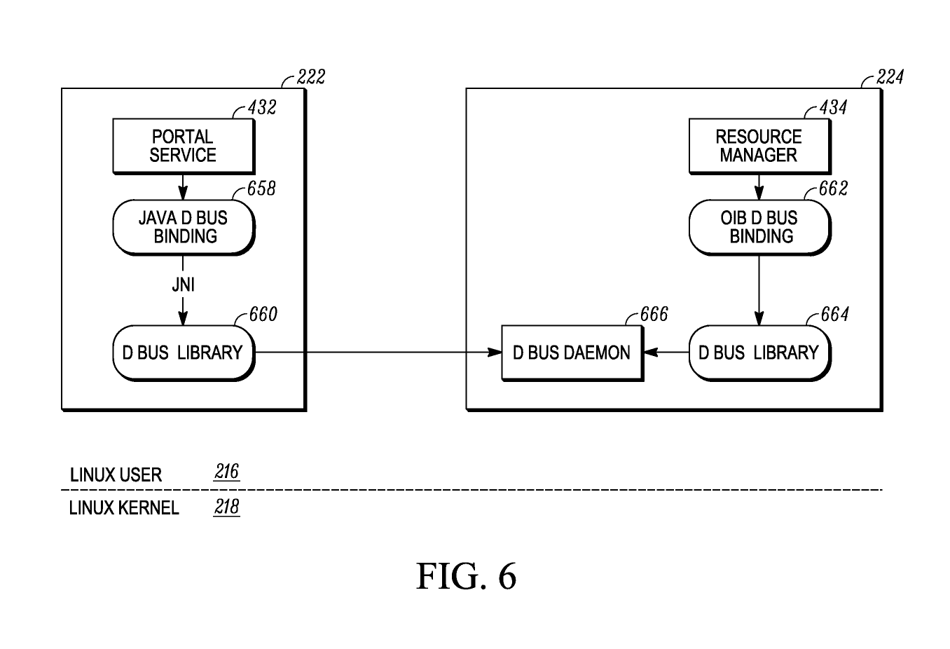

Referring to FIG. 6, a more detailed communication path between the first OSE 222 and the second OSE 224 described in FIG. 5 is provided, in accordance with some embodiments. An inter-process communication (IPC) system is configured to manage the inter-environment communication flow between the first OSE 222 and the second OSE 224. The portal service 426 communicates with a DBUS Binding 658, which is a software package containing programming language and executable instructions configured to communicate with a DBUS library 660. The resource manager 634 communicates with a Glib DBUS binding 662, which also is a software package containing programming language and executable instructions configured to communicate with a DBUS library 664 configured for the second OSE 224. Both the first OSE 222 DBUS library 660 and the second OSE 224 DBUS library 664 communicate through a DBUS Daemon 666, which is logically part of the second OS 24, and acts as the communication link between the two operating environments.

Embodiments described above with reference to FIGS. 1-6 include embodiments in which the first OSE 222 generates graphical data from which an OSE window 118 is rendered by a second OSE 224 within a window 320 (see FIG. 3). In some of these embodiments, tabs 326 (FIG. 3) are generated by the second OSE 224 within the window 320 and are positioned along the top of and adjacent to the first OSE window 118. These tabs may be used to indicate the status of some of the applications of the first OSE 222—that is, the applications that run in native mode on the middleware of the first OSE 222 and are controlled by the first OSE 222. Some examples of such applications are a phone book, a call connection application, a web browser, a phone settings application, and a game. The status (the state) of the applications of the first OSE 222 can be one of not started, closed, open-running, and open suspended. In some embodiments, only one application can be in the open-running state. This open-running application is responsive to communications from the second OSE that a user event (e.g., a click or selection) has occurred within the region of the first OSE window 118. The tabs serve as indicators of the statuses of corresponding applications that are in an open state, which includes the open-running state and the open-suspended state. Each tab also identifies the corresponding open application with a name. The tabs may be classified as application status indicators. There may be limit to the number of open applications that are rendered, due to graphical space limitations. In this instance, the tabs that are shown may be determined by one of a variety of rules, of which just one example is showing those for the applications whose status (state) has most recently changed. The status of the open-running application may be indicated by visually integrating that tab with the window 118 by such techniques as making the back ground color and/or the border of the tab for the running-open application different from the background color and/or border of the tabs for the running-suspended applications. In some embodiments, it may be practical to visually integrate the tab for the running-open application with the first OSE window 118 that is rendering the running-open application, by not having a border between them, as is shown for the third from left tab of the tabs 326 in FIG. 3, and by having a common background color.

The tabs described above are one form of application status indicators. Another form is soft buttons. A first set of soft buttons 335 are shown in the system status bar 330 of the device 310 in FIG. 3. This first set of buttons shows the statuses of windows 320, 325, 338 and is rendered by the second OSE in a conventional manner. The middle one of the first set of soft buttons 335 shows that the window 320 is in focus for the second OSE 224. A second set of soft buttons 340 is rendered by the second OSE. These soft buttons 340 identify open applications of the first OSE 222 and show the statuses of the first OSE applications that are open, and they could be rendered whether or not the window 320 is in focus. In embodiments in which the set of soft buttons 340 are rendered, the tabs 326 may not be rendered by the second OSE, since they indicate redundant information. The second set of soft buttons 340 are shown in an exemplary location of the desktop 318, but could be located elsewhere. For example, the window 320 could be sufficiently wider than the soft buttons and they could fit alongside the first OSE window 118 within window 320. As for tabs, there may be a limit on the number of soft buttons that can be rendering, and the choice of which to render could be by similar rules.

Other forms of application status indicators are possible. For example, icons could be used to identify which application is being represented, and the appearance of the icon could be changed (for example, different background colors or different brightnesses could be used) to indicate the current status (state). As for the tabs and soft buttons described above, these could be located anywhere within the desktop or window of the second application, but not within the first OSE window 118 when it is rendered within the window of the second OSE, inasmuch as the application status indicators are being rendered by the second OSE.

Although the embodiments herein above have been based on an aspect of the first and second OSE that they are running on one central processing unit, this configuration is not used in all embodiments. In some embodiments the device 110 is not a mobile device. For example, a first device may be a tablet that hosts a first OSE on a central processing unit of the first device and a second device may be a desktop that hosts the second OSE on a central processing unit of the second device. The second OSE may then display application status indicators for applications of the first OSE, as described above and further below. In some embodiments, the window of the first OSE is not rendered on the second device. This embodiment may be appropriate when the first and second devices are visible to the user but the first device is not readily accessible and is more generally an output device.

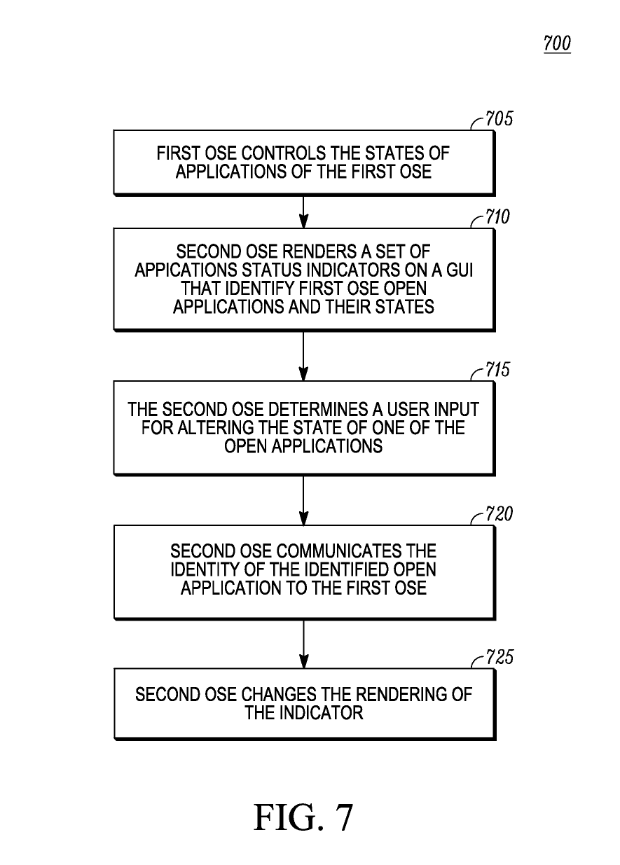

Referring now to FIG. 7, a flow chart 700 shows some steps of a method for user interface, in accordance with some embodiments. At step 705, a first operating system environment (first OSE) controls the states of a set of applications of the first OSE. Each application is controlled to be in one of at least a closed state, an open-running state, and an open-suspended state.

At step 710, a second operating system environment (second OSE) renders a set of application status indicators on a graphical user interface. Each application status indicator indicates an identity and a current state of one of the open applications of the first OSE, wherein the open applications comprise applications that are in one of the open-running and open-suspended states. Note that in some embodiments, the application status indicators may indicate applications that are in the closed state. Note also that other states may exist, of which one example is a not started state. The not-started state may be indicated in an identical manner as the open-suspended state in some embodiments. Another example is an open-running-but-not-in-focus application state. The open-running-but-not-in-focus state may be indicated in an identical manner as the open-suspended state in some embodiments.

At step 715 the second OSE determines a user input to alter the state of one of the applications. The user input identifies the application and a new (different) state. The application so identified is hereafter referred to as the identified application. The identified application is one of the open applications. The user input indicates that the current status of the identified application is to be altered to a different state that is one of at least closed, open-running, and open-suspended. At step 720, the second OSE communicates to the first OSE an identity of the identified application and the different state. At step 725 the second OSE changes the rendering of the application status indicator of the identified application to indicate the different state.

It will be appreciated that the first OSE in some instances will open or close an application without input from the second OSE. These instances may be due to global or system events detected or caused by the first OSE. An example of an event detected by the first OSE is a received call. For some of these events, the first OSE may alter the open or closed state of a first OSE application, and notify the second OSE of the application identity and the new state. The second OSE can then modify the application status indicators accordingly. Also, when the first OSE is performing rendering of the first OSE on a display without the first OSE window being rendered within a window of the second OSE, such as when the second OSE is not running, or when each OSE is presenting its OSE window on different displays, then human input is senses by and responded to by the first OSE.

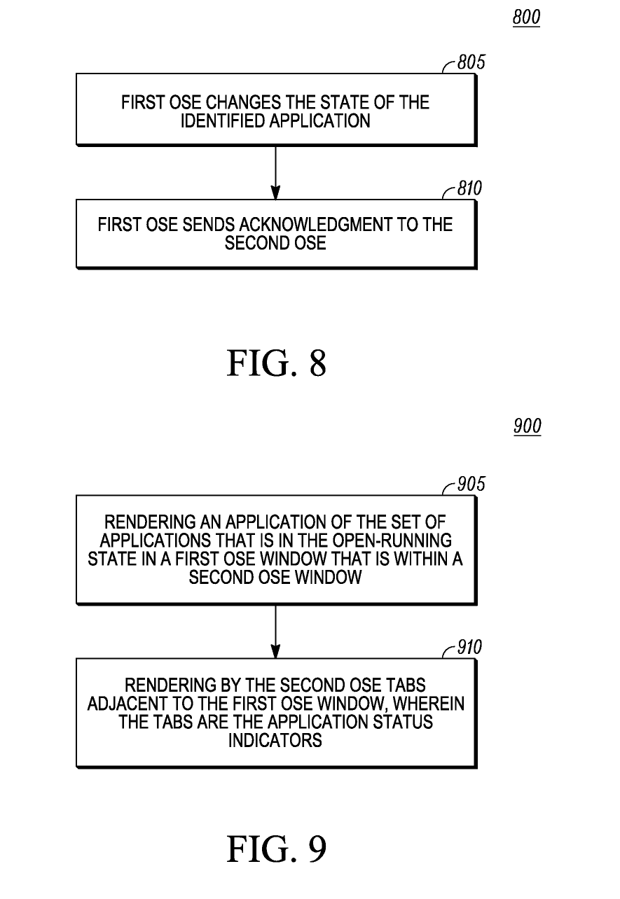

Referring to FIG. 8, a flow chart 800 shows some steps of the method for user interface, in accordance with some embodiments. At step 805, the first OSE changes the state of the identified application to the different state in response to the communication. At step 810 an acknowledgement that the identified application has been changed to the different state is communicated from the first OSE to the second OSE.

Referring to FIG. 9, a flow chart 900 shows some steps of the method for user interface, in accordance with some embodiments. At step 905, one of the set of applications that is in a state of open-running is rendered in a first OSE window. The first OSE window is rendered within a second window by the second OSE. At step 910, the second OSE tabs are rendered within the second window adjacent to the first OSE window. The tabs are the application status indicators.

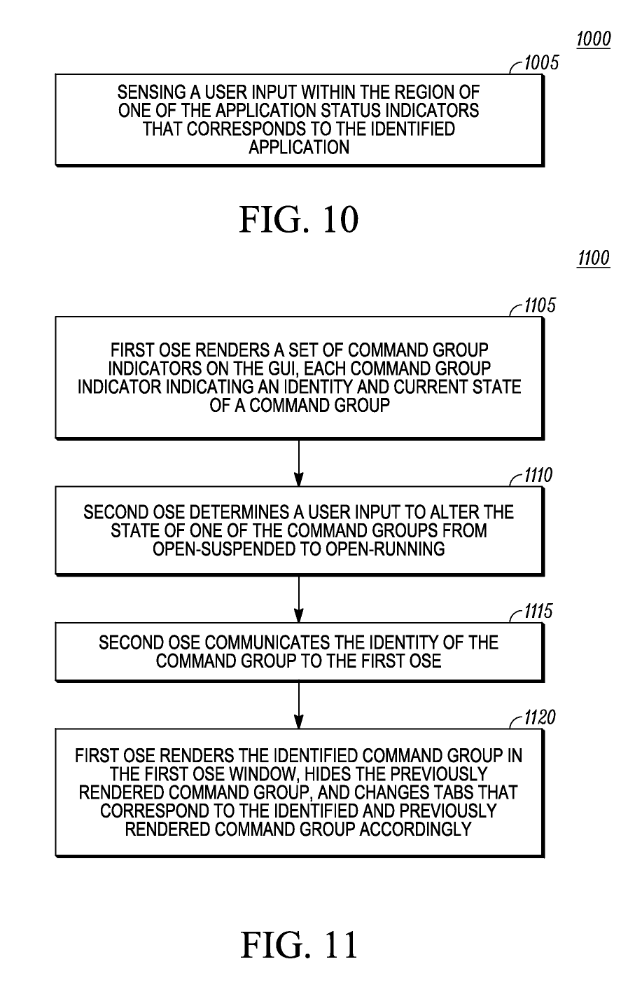

Referring to FIG. 10, a flow chart 1000 shows some steps of the method for user interface, in accordance with some embodiments. At step 1005, the determining by the second OSE of a user input to alter the state of the identified application, which is described above with reference to step 715, comprises sensing a user input within the region of the one of the application status indicators that corresponds to the identified application. This determination is made while the identified application is within focus, if the identified application is rendered within a window of the second OSE.

Referring to FIG. 11, a flow chart 1100 shows some steps of the method for user interface, according to some embodiments. In these embodiments, at least one of the applications of the first OSE includes a function called ribbons that renders one or more ribbons. Each ribbon comprises a group of related commands that are identified, such as by icons or text, and one of the ribbons is rendered in the first OSE window at a time. The ribbon that is rendered is selected by the user by interfacing with a tab. Each tab identifies one ribbon. Thus, when the identified application is changed to an open-running state, and when the identified application comprises a ribbon application that renders one group at a time of a plurality of groups of commands (command groups) for the identified application, the following steps may be performed.

At step 1105 the first OSE renders a set of command group indicators in the first OSE window on a graphical user interface. Each command group indicator indicates an identity of a command group. Each tab may further indicate the state of each command group, which may be one of open-running and open-suspended. At step 1110 the second OSE determines a user input to alter the state of one of the command groups from open-suspended to open-running. At step 1115 the second OSE communicates to the first OSE an identity of the command group for which the state is to be altered to the open-running state. The first OSE then renders at step 1120 the identified command group in the first OSE window and hides the previously rendered command group, and changes the tabs of the identified command group and the previously rendered command group accordingly, to indicate their new status. The indication may be one of the indications described above for application status tabs.

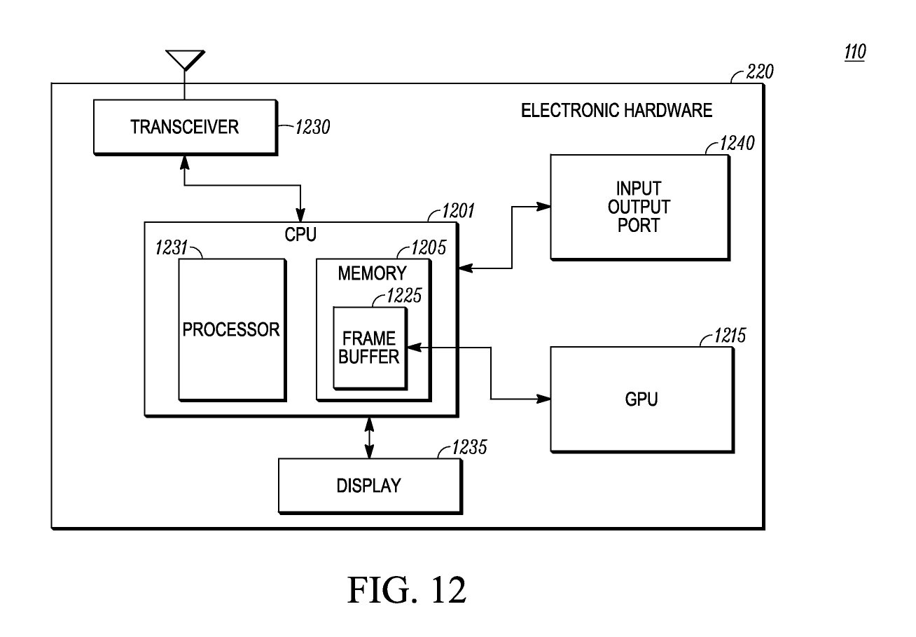

Referring to FIG. 12, a block diagram shows some hardware blocks of the mobile device 110, in accordance with some embodiments. This block diagram also represents a second device for some embodiments, although in such embodiments, the second device typically would not include a transceiver such as transceiver 1213. Mobile device 110 preferably comprises device electronic hardware 220 that includes a central processing unit (CPU) 1201 comprising memory 1205 coupled to a processor 1231. Memory 1205 may comprise random access memory, flash memory, read only memory, disk memory, or any combination thereof. The mobile device also comprises physical hardware, such as a housing, which is not shown in FIG. 12. The memory 1205 stores computer executable instructions which are configured to perform various functions and operations, as described herein. In some embodiments the electronic hardware 220 may include a graphics processing unit (GPU) 1215 that is a specialized chipset for rapidly rendering images. The GPU 1215 is typically given direct access to a portion of the memory 1205 that is reserved for a frame buffer 1225, which is used for storing a current image of the GUI desktop 318 in the form of pixel values. In certain embodiments of the hardware 220, there will be a second frame buffer in memory 1205 (not shown in FIG. 12). This may occur when there are two displays. This could occur in a situation in which a mobile device has two displays (e.g., a large tablet display one side that shows a desktop WIW similar to WIW 320 and a small display facing another direction that displays the first OSE window 118 or a second WIW). This could also occur when the WIW 320 is presented on external device 310 and the first OSE window 118 or a second WIW is presented on the mobile device 110 simultaneously. In certain embodiments, such as those in which the GUI 112 of the mobile device presents a WIW managed by the second OSE 224 to render the first OSE window 118, the WIW image boundary may be identical to the first OSE window 118 image boundary (i.e., titles and tabs may not be rendered when the WIW is rendered on the display 113 of the mobile device 110), such that WIW is not visibly distinguishable in the form generally described as a desktop.

The software environment 216 (FIG. 2) executed by central processing unit 1201 includes first operating system environment 222 and second operating system environment 224 that are each in communication with the single Linux kernel 218, which is also executed by the CPU 1201. The single Linux kernel 218 is also in communication with many items of the electronic hardware 220, which are coupled to the CPU 1201, of which a few examples are a transceiver 1230, a touch-sensitive display 1235, and an input output port 1240. The electronic hardware 220 includes input-output ports, of which one is a port 1240 that can be used to couple the mobile device 110 to the external device 310. This port 1240 can be an HDMI cable port or other type of cable (wired) port that is compatible with the data communication requirements of the external device 310. In some embodiments, it can be a wireless port that can couple an analog or digital video signal to the external device 310. Both a wired and a wireless port may be provided. In some embodiments, a docking station connector may be included in the electronic hardware 220. The processor 1231 may be a processor having multiple cores, or may be a reduced instruction set processor, or other type of processor.

While the invention has been particularly shown and described with reference to a particular embodiment, it will be understood by those skilled in the art that various changes in form and details may be made therein without departing from the spirit and scope of the invention. For example, the WIW 320 may be rendered on display 113 by the second OSE 224, when the external device 310 is not coupled to the mobile device 110 or is coupled to the mobile device 110 and is also rendering the WIW, or when the external device 310 is coupled to the mobile device 110 but is inactive. It is specifically intended that the present invention not be limited to the embodiments and illustrations contained herein, but include modified forms of those embodiments including portions of the embodiments and combinations of elements of different embodiments as come within the scope of the following claims.

The processes illustrated in this document, for example (but not limited to) the method steps described in FIGS. 7-11, may be performed using programmed instructions contained on a computer readable medium which may be read by processor of a CPU such as processor 1231 of CPU 1201. A computer readable medium may be any tangible medium capable of storing instructions to be performed by a microprocessor. The memory 1205 includes such a medium. The medium may be one of or include one or more of a CD disc, DVD disc, magnetic or optical disc, tape, and silicon based removable or non-removable memory. The programming instructions may also be carried in the form of packetized or non-packetized wireline or wireless transmission signals.

1. A method for user interface, comprising:
controlling by a first operating system environment (first OSE) the states of a set of applications of the first OSE, wherein each application is controlled to be in one of at least a closed state, an open-running state, and an open-suspended state;
rendering by a second operating system environment (second OSE) a set of application status indicators on a graphical user interface each of which indicates an identity and a current state of one of the open applications of the first OSE, wherein the open applications comprise applications that are in one of the open-running and open-suspended states;
determining by the second OSE a user input to alter the state of one of the applications (an identified application) of the open applications to a different state that is one of at least closed, open-running, and open-suspended;
communicating by the second OSE to the first OSE an identity of the identified application and the different state; and
changing by the second OSE the rendering of the application status indicator of the identified application to indicate the different state.

2. The method according to claim 1, further comprising:
changing by the first OSE the state of the identified application to the different state in response to the communication; and
communicating from the first OSE to the second OSE an acknowledgement that the identified application has been changed to the different state.

3. The method according to claim 1, further comprising:
receiving by the second OSE from the first OSE a communication that identifies one application of the set of applications that is being changed by the first OSE (a first OSE identified application) from a second current state to a second different state;
modifying by the second OSE a corresponding application status indicator to show the identity of the first OSE identified application that is being changed and to show the second different state.

4. The method according to claim 3, further comprising:
modifying by the second OSE another of the set of application status indicators from open-running to open-suspended when the one of the set of application status indicators is changed to open-running.

5. The method according to claim 1, further comprising:
executing the first OSE and second OSE by the same central processing unit, and running the first and second OSE independently on the same central processing unit.

6. The method according to claim 1, further comprising rendering one of the set of applications that is in a state of open-running in a first OSE window, wherein the first OSE window is rendered within a second window by the second OSE.

7. The method according to claim 6, further comprising rendering by the second OSE tabs adjacent to the first OSE window, wherein the tabs are the application status indicators.

8. The method according to claim 1, wherein the determining by the second OSE a user input to alter the state of the identified application comprises sensing a user input within the region of one of the application status indicators that corresponds to the identified application.

9. The method according to claim 1, wherein the identified application is changed to the open-running state, and wherein the identified application comprises a ribbon application that renders one group at a time of a plurality of groups of commands (command groups) for the identified application, and wherein the method further comprises:
rendering by the first OSE a set of command group indicators on the graphical user interface, each command group indicator indicating an identity and a current state of a command group, wherein the state of each command group is one of open-running and open-suspended;
determining by the second OSE a user input to alter the state of one of the command groups from open-suspended to open-running; and
communicating by the second OSE to the first OSE an identity of the command group for which the state is to be altered to the open-running state.

10. An apparatus comprising:
a first device comprising a central processing unit (CPU);
a second device comprising a central processing unit (CPU); and
a graphical user interface (GUI) coupled to one of the first and second devices,
wherein the CPU of the first device executes a first operating system environment (first OSE) that controls the states of a set of applications of the first OSE, wherein each application is controlled to be in one of at least a closed state, an open-running state, and an open-suspended state, and
wherein the CPU of the second device executes a second operating system environment (second OSE) that
renders a set of application status indicators on the GUI, each of which indicates an identity and a current state of one of the open applications of the first OSE, wherein the open applications comprise applications that are in one of the open-running and open-suspended states;
determines a user input to alter the state of one of the applications (a identified application) of the open applications to a different state that is one of at least closed, open-running, and open-suspended;
communicates to the first OSE an identity of the identified application and the different state; and
changes the rendering of the application status indicator of the identified application to indicate the different state.

11. The apparatus according to claim 10, wherein the first device and the second device are the same device, which has one CPU.

12. A tangible computer readable medium that stores instructions that are executable by a processor for performing a method of rendering a window that comprises:
controlling by a first operating system environment (first OSE) the states of a set of applications of the first OSE, wherein each application is controlled to be in one of at least a closed state, an open-running state, and an open-suspended state;
rendering by a second operating system environment (second OSE) a set of application status indicators on a graphical user interface each of which indicates an identity and a current state of one of the open applications of the first OSE, wherein the open applications comprise applications that are in one of the open-running and open-suspended states;
determining by the second OSE a user input to alter the state of one of the applications (a identified application) of the open applications to a different state that is one of at least closed, open-running, and open-suspended;
communicating by the second OSE to the first OSE an identity of the identified application and the different state; and
changing by the second OSE the rendering of the application status indicator of the identified application to indicate the different state.

13. The tangible computer readable medium according to claim 11, further comprising:
changing by the first OSE the state of the identified application to the different state in response to the communication; and
communicating from the first OSE to the second OSE an acknowledgement that the identified application has been changed to the different state.

14. The tangible computer readable medium according to claim 11, further comprising:
receiving by the second OSE from the first OSE a communication that identifies one application of the set of applications that is being changed by the first OSE (a first OSE identified application) from a second current state to a second different state;
modifying by the second OSE a corresponding application status indicator to show the identity of the first OSE identified application that is being changed and to show the second different state.

15. The tangible computer readable medium according to claim 14, further comprising:
modifying by the second OSE another of the set of application status indicators from open-running to open-suspended when the one of the set of application status indicators is changed to open-running.

16. The tangible computer readable medium according to claim 11, further comprising:
executing the first OSE and second OSE by the same central processing unit, and running the first and second OSE independently on the same central processing unit.

17. The tangible computer readable medium according to claim 11, further comprising rendering one of the set of applications that is in a state of open-running in a first OSE window, wherein the first OSE window is rendered within a second window by the second OSE.

18. The tangible computer readable medium according to claim 17, further comprising rendering by the second OSE tabs adjacent to the first OSE window, wherein the tabs are the application status indicators.

19. The tangible computer readable medium according to claim 11, wherein the determining by the second OSE a user input to alter the state of the identified application comprises sensing a user input within the region of one of the application status indicators that corresponds to the identified application.

20. The tangible computer readable medium according to claim 11, wherein the identified application is changed to the open-running state, and wherein the identified application comprises a ribbon application that renders one group at a time of a plurality of groups of commands (command groups) for the identified application, and wherein the method further comprises:
rendering by the first OSE a set of command group indicators on the graphical user interface, each command group indicator indicating an identity and a current state of a command group, wherein the state of each command group is one of open-running and open-suspended;
determining by the second OSE a user input to alter the state of one of the command groups from open-suspended to open-running; and
communicating by the second OSE to the first OSE an identity of the command group for which the state is to be altered to the open-running state.
